(19) United States
(12) Patent Application Publication
(10) Pub. No.: US 2007/0233833 A1
(43) Pub. Date: Oct. 4, 2007

(54) Data transmission system for electronic devices with server units

(75) Inventor: Tsung-Pin Wang, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/393,527

(22) Filed: Mar. 29, 2006

(51) Int. Cl. G06F 15/173

(52) U.S. Cl. 709/223

(57) ABSTRACT

A data transmission system applicable to an electronic device with server units is provided. The electronic device also has a management unit for managing the server units, and the management unit includes a transmission interface for transmitting data to a monitoring mainframe. Each of the server units and the management unit has a controller. Management buses electrically connect the controllers of the server units with the controller of the management unit. Switching units are disposed in the server units and are able to be switched on by the controllers of the server units and establish a direct link between data storage areas of the server units and the transmission interface of the management unit without the need for the management bus.

### FIELD OF THE INVENTION

The present invention relates to a data transmission system, and more particularly, to a data transmission system applicable to a blade server without the need to transmit data via a IPMB (Intelligent Platform Management Bus).

### BACKGROUND OF THE INVENTION

Along with rapid development of computer technology, the processing speeds of the computers increase accordingly, and with the progress in network technology, communication channels are able to be established between computers, allowing data to be exchanged between computers in various different regions successfully and swiftly.

For example, blade servers are the result of integrating computer and network technologies, which greatly enhance network management efficiency. In order to fully utilize the overall efficiency of blade servers, server, network and/or computer manufacturers have researched and developed various kinds of management interfaces, such as the IPMI (Intelligent Platform Management Interface) technique, in which a IPMB (Intelligent Platform Management Bus) is developed in compliance with the BMC (Base Management Controller) in each of server units in a blade server, so as to enhance data transmission efficiency of the BMC. FIG. 1 is a schematic block diagram illustrating the basic structure of a data transmission system of a conventional blade server. As shown, the blade server 1 is equipped with a plurality of server units 10 and a management unit 11 for managing the various server units 10. Each of the server units 10 and the management unit 11 has a BMC (i.e. 100 and 110). BMC 100 of each server unit 10 is connected to the BMC 110 of the management unit 11 via for example a IPMB 12, so that the management unit 11 is able to manage the server units 10 via the IPMB 12 using a pre-stored management program 111. Transmission interfaces such as a NIC (Network Interface Card) 112 or serial port 113 are provided in the management unit 11 to enable network connection with a network system 2, so that data pre-stored in the data storage area 101 of each server unit 10 can be transmitted to a remote monitoring mainframe 3, or data sent from the monitoring mainframe 3 can be transmitted to the server units 10 to be managed via the network system 2, management unit 11 and IPMB 12. The management tasks may include performing update or installing processes of data in the data storage area 101 of the server units 10 (e.g. update or install BIOS programs or operation system) and processing operating status of the server unit 10 being remotely monitored, so as to facilitate network manager to manage the blade server. It should be noted that since blade servers, BMC and IPMB are well known to those with ordinary skill in the art, it will not be described in details.

However, when the network manager performs management for the blade server, whether the management task is for the remotely monitoring mainframe 3 to update or install data (e.g. update or install BIOS program or operating system) in the data storage area 101 of a server unit 10 or to obtain data stored in the data storage area 101 of a server unit 10, the BMC 110 of the management unit 11 has to obtain or transmit data to/from the server unit 10 via the IPMB 12. The data transmission process tends to increase the workload of the BMC 110 of the management unit 11, and the data transmission path involves the BMC 110 of the management unit 11, IMPB 12, BMC 100 of the server unit 10 and a serial transmission line 102 between the data storage area 101 and the BMC 100 of the server unit 10. Since this type of architecture has a very long data transmission path plus the IPMB 12 has a limited bandwidth, if the remotely monitoring mainframe 3 intends to read a server unit 10 while the management unit 11 needs to perform management to another server unit 10, the transmission load of the IPMB 12 and the workload of the BMC 110 of the management unit 11 increase, sometimes resulting in data packet lost.

Thus, there is a need for a data transmission system that enhances the data transmission efficiency of the blade servers while avoiding overloading the BMC of the management unit and the IPMB between the server units.

### SUMMARY OF THE INVENTION

In the light of forgoing drawbacks, an objective of the present invention is to provide a data transmission system applicable to an electronic device with a plurality of server units for transmitting data between the server units and a management unit that manages the server units, avoiding overloading the management bus between the server units and the management unit and data packet lost from occurring.

Another objective of the present invention is to provide a data transmission system applicable to an electronic device with a plurality of server units that reduces the transmission path between the server units and the management unit.

In accordance with the above and other objectives, the present invention provides a data transmission system applicable to an electronic device with a plurality of server units. The electronic device further comprises a management unit for managing each of the server units, the management unit including a transmission interface such that data is transmitted to a monitoring mainframe via the transmission interface. In one embodiment, the data transmission system comprises: a plurality of controllers disposed in each of the server units and the management unit; a plurality of management buses for electrically connecting the controllers in the server units with the controller in the management unit, respectively, allowing the management unit to manage each of the server units via the respective management bus; a plurality of switching units disposed in the server units and electrically connected to the controllers of the server units in which they reside; a first transmission line between each of the switching units and the transmission interface of the management unit; and a second transmission line between each of the switching units and a data storage area of respective server units; wherein when data is to be read from one of the server units by the monitoring mainframe, a data read request is sent to the controller in said server unit, which then allows the respective switching unit to short circuit the first transmission line and the second transmission line connected thereto, thereby establishing a direct link between the data storage area of said server unit and the transmission interface of the management unit bypassing the management bus.

Furthermore, in another embodiment of the present invention, the data transmission system comprises: a plurality of controllers disposed in each of the server units and the management unit; a plurality of management buses for electrically connecting the controllers in the server units with the controller in the management unit, respectively, allowing the management unit to manage each of the server units via the respective management bus; a plurality of switching units disposed in the server units and electrically connected to the controllers of the server units in which they reside; a first transmission line between each of the switching units and the transmission interface of the management unit; and a second transmission line between each of the switching units and a data storage area of respective server units;

wherein when data is to be transmitted from one of the server units to the monitoring mainframe, a data transmission request is first sent from the controller of said server unit to the controller of the management unit, the management unit then opens its transmission interface, and the controller in said server unit allows the respective switching unit to short circuit the first transmission line and the second transmission line connected thereto, thereby establishing a direct link between the data storage area of said server unit and the transmission interface of the management unit bypassing the management bus.

Thus, the data transmission system applicable to an electronic device with a plurality of server units provides a more direct link for data transmission between the transmission interface of the management unit and the data storage area of the server units, bypassing the controllers of the management unit and the server units and the management bus, reducing workload of the management bus and the controllers, and hence reducing the risk of losing data packets and enhancing data transmission efficiency.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a schematic block diagram illustrating the basic structure of a data transmission system of a conventional blade server; and

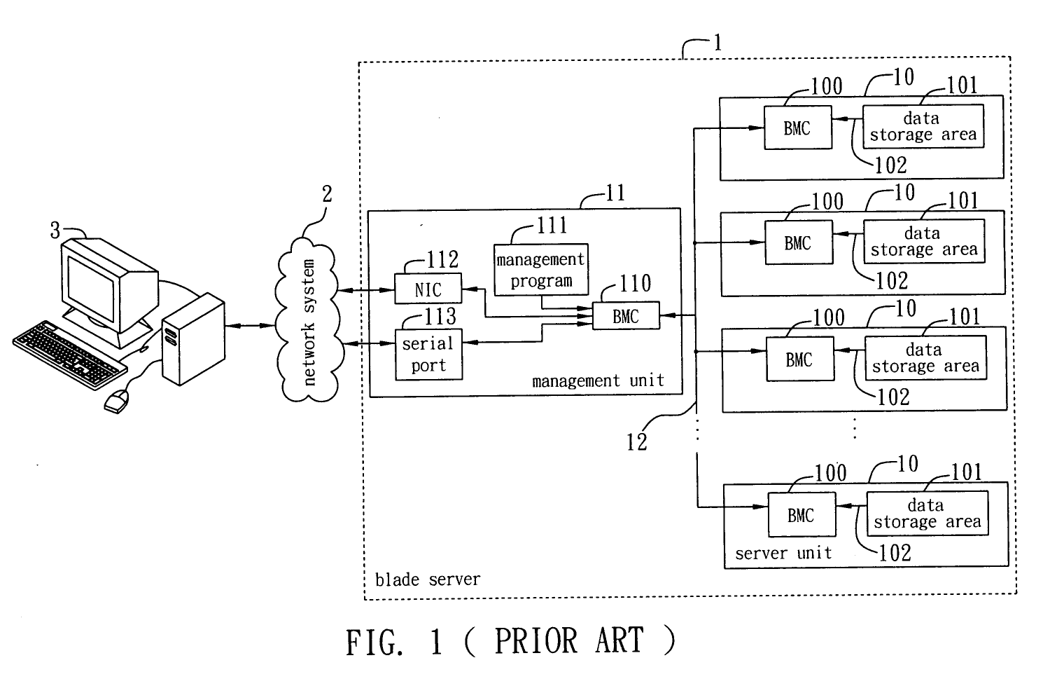

FIG. 2 is a schematic block diagram illustrating the basic structure of the data transmission system applied to an electronic device with a plurality of server units according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

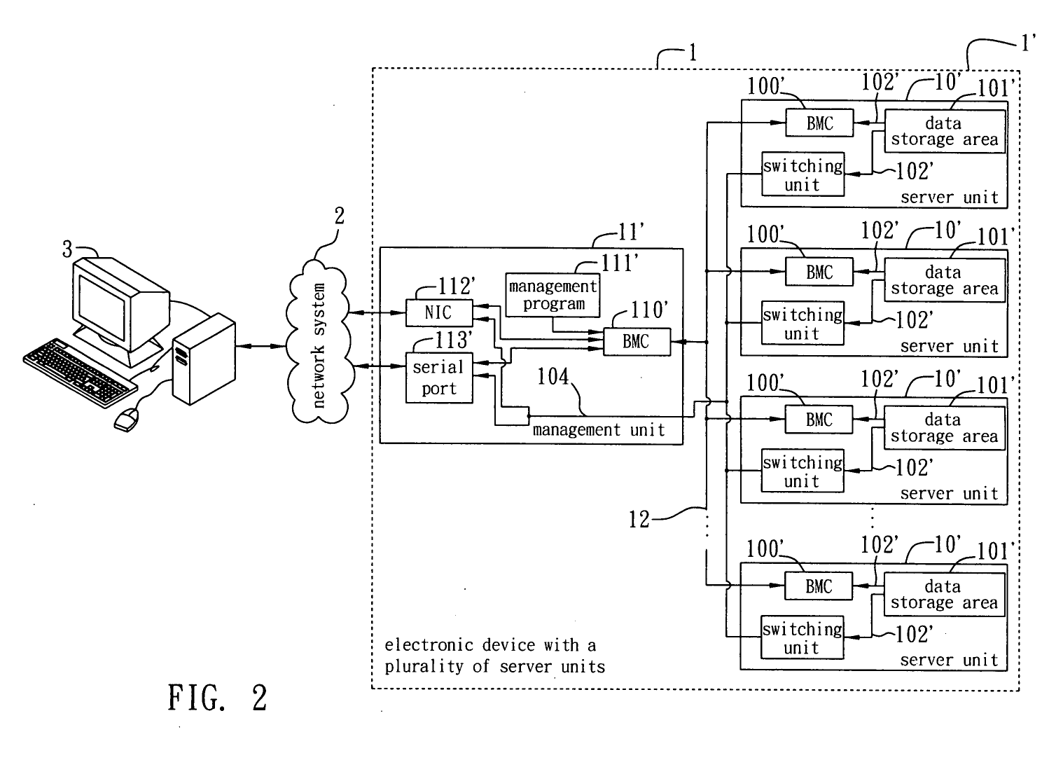

Referring to FIG. 2, shown is a schematic block diagram illustrating the basic structure of the data transmission system applied to an electronic device with a plurality of server units according to the present invention. The electronic device with the plurality of server units in this embodiment is for example a blade server. As shown, the electronic device 1′ further comprises a management unit 11′ for managing the server units 10′. Each of the server units 10′ and the management unit 11′ has a BMC (Base Management Controller) (i.e. 100′ and 110′). BMC 100′ of each server unit 10′ is connected to the BMC 110′ of the management unit 11′ via for example a IPMB 12, so that the management unit 11 is able to manage the server units 10′ via the IPMB 12 using a pre-stored management program 111′. Transmission interfaces such as a NIC (Network Interface Card) 112′ or serial port 113′ are provided in the management unit 11′ to enable network connection with a network system 2, so that data pre-stored in the data storage area 101′ of each server unit 10′ can be transmitted to a remote monitoring mainframe 3 via the network system 2. It should be noted that the architecture of the electronic device 1′ is similar to that of a conventional blade server, so only the differences between them will be discussed for simplicity.

Furthermore, it should also be noted that the monitoring mainframe 3, apart from being connected to the electronic device 1′ via the network system 2, can also be directly connected to the electronic device 1′ via the serial port 113′ of the management unit 11′. In other words, the monitoring mainframe 3 can be connected to the electronic device 1′ in a remote or local manner. Therefore, the connection of the monitoring mainframe 3 is not limited to that shown in FIG. 2.

In the data transmission system applied to an electronic device with a plurality of server units of the present invention, each of the server unit 10′ of the electronic device has a switching unit 103 for switching circuits. The switching unit 103 is electrically connected to the BMC 100′ of the server unit 10′ in which it resides, and each of them is electrically connected to the transmission interfaces (i.e. NIC 112′ or serial port 113′) of the management unit 11′ via a serial transmission line 104. The role of the switching units 103 is to short circuit the serial transmission lines 102′ and 104 at either side of it, such that data in the data storage areas 101′ of the server units 10′ can be transmitted directly to the transmission interfaces of the management unit 11′ through the serial transmission lines 102′ and 104 at either side of the switching units 103. This bypasses the IPMB 12 between the management unit 11′ and the server units 10′, reducing the workload thereof.

For example, when the management unit 11′ or the remotely monitoring mainframe 3 intends to read data stored in the data storage area 101′ of a server unit 10′ (the data is for example the operating status of the server unit 10′ or data related to BIOS program and/or operating system), the management unit 11′ sends a data read request to the BMC 100 of the server unit 10′ to be read via the IPMB 12 using the stored management program 111′. Upon receiving the data read request, the BMC 100′ of that server unit 10′ makes the switching unit 103 to short circuit the serial transmission lines 104 and 102′ between the server unit 10′ and the management unit 11′, allowing data to be directly transmitted from the data storage area 101′ to the transmission interfaces (i.e. NIC 11 2′ or serial port 113′) of the management unit 11′ via the serial transmission lines 104 and 102′ and the switching unit 103. Thereby, the remotely monitoring mainframe 3 is able to obtain data stored in the data storage area 101′ of the server unit 10′.

In addition, the data transmission system of the present invention apart from enabling the management unit 11′ or the remotely monitoring mainframe 3 to read data from each of the server units 10′ also enables the server units 10′ to transmit data to the remotely monitoring mainframe 3. The server unit 10′ that intends to transmit data first sends a data transmission request to the BMC 110′ of the management unit 11′ via the IPMB 12 to request the management unit 11′ to open the transmission path of its transmission interfaces (i.e. NIC 112′ or serial port 113′), then the server unit 10′ makes the switching unit 103 at its end to short circuit the serial transmission lines 104 and 102′, allowing data to be sent from the server unit 10′ to the transmission interfaces (i.e. NIC 112′ or serial port 113′) of the management unit 11′ and in turn sent to the remotely monitoring mainframe 3.

Thus, the data transmission system applicable to an electronic device with a plurality of server units provides a more direct link for data transmission between the transmission interface of the management unit and the data storage area of the server units, bypassing the BMCs of the management unit and the server units and the IPMBs, and hence reducing the risk of losing data packets and enhancing data transmission efficiency.

The above embodiments are only used to illustrate the principles of the present invention and they should not be construed as to limit the present invention in any way. The above embodiments can be modified by those with ordinary skills in the arts without departing from the scope of the present invention as defined in the following appended claims.

What is claimed is:

1. A data transmission system applicable to an electronic device with a plurality of server units, the electronic device further comprising a management unit for managing each of the server units, the management unit including a transmission interface such that data is transmitted to a monitoring mainframe via the transmission interface, the data transmission system comprising:
a plurality of controllers disposed in each of the server units and the management unit;
a plurality of management buses for electrically connecting the controllers in the server units with the controller in the management unit, respectively, allowing the management unit to manage each of the server units via the respective management bus;
a plurality of switching units disposed in the server units and electrically connected to the controllers of the server units in which they reside;
a first transmission line between each of the switching units and the transmission interface of the management unit; and
a second transmission line between each of the switching units and a data storage area of the respective server unit;
wherein when data is to be read from one of the server units by the monitoring mainframe, a data read request is sent to the controller in said server unit, which then allows the respective switching unit to short circuit the first transmission line and the second transmission line connected thereto, thereby establishing a direct link between the data storage area of said server unit and the transmission interface of the management unit bypassing the respective management bus.

2. The data transmission system of claim 1, wherein the electronic device includes a blade server, and the controllers in the management unit and the server units include Base Management Controllers (BMCs).

3. The data transmission system of claim 2, wherein the management buses include Intelligent Platform Management Buses (IPMBs).

4. The data transmission system of claim 2, wherein the transmission interface of the management unit includes at least one of a network card interface and a serial port.

5. The data transmission system of claim 1, wherein the management buses include Intelligent Platform Management Buses (IPMBs).

6. The data transmission system of claim 1, wherein the transmission interface of the management unit includes at least one of a network card interface and a serial port.

7. A data transmission system applicable to an electronic device with a plurality of server units, the electronic device further comprising a management unit for managing each of the server units, the management unit including a transmission interface such that data is transmitted to a monitoring mainframe via the transmission interface, the data transmission system comprising:
a plurality of controllers disposed in each of the server units and the management unit;
a plurality of management buses for electrically connecting the controllers in the server units with the controller in the management unit, respectively, allowing the management unit to manage each of the server units via the respective management bus;
a plurality of switching units disposed in the server units and electrically connected to the controllers of the server units in which they reside;
a first transmission line between each of the switching units and the transmission interface of the management unit; and
a second transmission line between each of the switching units and a data storage area of the respective server unit;
wherein when data is to be transmitted from one of the server units to the monitoring mainframe, a data transmission request is first sent from the controller of said server unit to the controller of the management unit, the management unit then opens its transmission interface, and the controller in said server unit allows the respective switching unit to short circuit the first transmission line and the second transmission line connected thereto, thereby establishing a direct link between the data storage area of said server unit and the transmission interface of the management unit bypassing the respective management bus.

8. The data transmission system of claim 7, wherein the electronic device includes a blade server, and the controllers in the management unit and the server units include Base Management Controllers (BMCs).

9. The data transmission system of claim 8, wherein the management buses include Intelligent Platform Management Buses (IPMBs).

10. The data transmission system of claim 8, wherein the transmission interface of the management unit includes at least one of a network card interface and a serial port.

11. The data transmission system of claim 7, wherein the management buses include Intelligent Platform Management Buses (IPMBs).

12. The data transmission system of claim 7, wherein the transmission interface of the management unit includes at least one of a network card interface and a serial port.
